(19) United States
(12) Patent Application Publication
(10) Pub. No.: US 2007/0022455 A1
(43) Pub. Date: Jan. 25, 2007

(54) Image display device, image display method and image display system

(76) Inventors: Takeshi Endou, Kanagawa (JP); Kazuya Demura, Kanagawa (JP)

Correspondence Address: MCDERMOTT WILL & EMERY LLP, 600 13TH STREET, N.W., WASHINGTON, DC, 20005-3096, US

(21) Appl. No.: 11/483,658

(22) Filed: Jul. 11, 2006

(30) Foreign Application Priority Data
Jul. 11, 2005 (JP) P2005-201898

(51) Int. Cl. H04N 7/173

(52) U.S. Cl. 725/105; 348/333.01

(57) ABSTRACT

An image processing unit 103 detects motion information of an image photographed by an image sensor 102 and sends the motion information to a control unit 14. The control unit 104 generates an angle control signal according to the motion information of the image and sends the angle control signal to a signal transmitting unit 105. The signal transmitting unit 105 transmits the angle control signal to an image content distribution server 110 over a network 120. A signal receiving unit 106 receives an image signal from the image distribution server 110 over the network 120. A display 101 displays image information received by the signal receiving unit 106.

### BACKGROUND OF THE INVENTION

1. Field of the Invention

The present invention relates to a means for allowing a user of a display terminal to select a camera angle in a system for distributing images photographed by a plurality of cameras to the display terminal, which can be used for an industrial field such as a monitoring system and a broadcasting system.

2. Description of the Related Art

In a conventional television broadcast, a camera angle of image contents was determined by a broadcasting station. For example, in a broadcast of a baseball game, there are a camera angle from behind a batter and a camera angle from behind a pitcher. Since the camera angle is selected according to the judgment of the broadcasting station, a viewer cannot view the image while selecting the camera angle.

As a means for allowing a user to view an image while selecting a camera angle, there is a closed circuit television (CCTV) system used for a monitoring system or a security apparatus. In the CCTV system, a plurality of cameras is connected to a display device using a video switch and thus the user can monitor an object while selecting any one from the cameras.

FIG. 14 is a view showing a schematic configuration of a CCTV system. An input unit 1401 is a user interface block for allowing a user to select a camera angle. As a typical input means, a keyboard 1402, a joystick 1403 and a mouse 1404 are used.

A control unit 1405 is a block for controlling a video switch 1406 and controls the video switch 1405 such that the camera angle desired by the user is obtained. The video switch 1406 selects a camera specified by the control unit 1405 from a plurality of cameras 1407 and transmits an image signal from the selected camera 1407 to a display 1408. The display 1408 displays an image.

As a means for improving an operability of the CCTV system, there is provided a method of using a viewpoint converting process and an image synthesizing process (for example, see Japanese Unexamined Application Publication No. 2000-152216).

However, the conventional technology has the following problems. First, when the CCTV system applies to a television broadcast, input signals of all the cameras must be always transmitted. Accordingly, since the amount of information increases proportional to the number of the cameras, the amount of information need be reduced for practical application.

Second, in the CCTV system, a pointing device such as a mouse or a joystick and a keyboard are required as an input means for selecting the camera. Accordingly, miniaturization and excellent operability of the display device cannot be compatible.

When a small-sized device such as a mobile phone is used as a display device, a plurality of functions must be assigned to a few buttons and thus the operation thereof becomes complicated. When a function is selected in the mobile phone, directional keys are generally used and thus the arrangement of the directional keys restricts the design of the display device.

### SUMMARY OF THE INVENTION

An object of the present invention is to provide an image display device, an image display method and an image display system, which can select any one from a plurality of cameras by a simple operation and simultaneously accomplish miniaturization and excellent operability of the display device.

According to the present invention, an image display device includes a display, an image sensor, an image processing unit, a control unit, a signal transmitting unit, and a signal receiving unit.

The image display device can transmit/receive a signal to/from an image content distribution server over a wired/wireless network. The image sensor is provided on a device to face a user and photographs a scene surrounding the face of the user who views the display.

The input by the user is performed by tilting the display device in all directions. When the user tilts the device, a visual field caught by the image sensor moves in all directions and thus the image of the sensor moves. The scene photographed by the image sensor is input to the image processing unit to obtain motion information of the image.

The control unit generates an angle control signal from the motion information of the image. The angle control signal of the control unit is transmitted to the image content distribution server using the signal transmitting unit over a network.

The image content distribution server distributes an image signal from the camera specified by the angle control signal to the user over the network. The image display device receives the image signal using the signal receiving unit and displays the image signal on the display.

According to an aspect of the present invention, there is provided an image display device including: an

image sensor which photographs a subject; an image processing unit which detects motion information of the subject from an image photographed by the image sensor; a control unit which generates an image control signal from the motion information; and a display which displays an image selected based on the image control signal.

By this configuration, since the image sensor detects the motion information of the subject from the photographed image to select the image according to the motion information of the subject, it is possible to select the image by a simple operation and simultaneously accomplish miniaturization and excellent operability of the image display device.

In the present invention, the image display device may further include a signal transmitting unit which transmits the image control signal to an image content distribution server over a network; and a signal receiving unit which receives the image selected by the image content distribution server based on the image control signal over the network.

In the present invention, the image sensor may be provided in a case of the image display device such that photographing can be performed in the approximately vertical direction of the display surface of the display, and photograph the face of a user who views the display.

In the present invention, the image processing unit may detect the motion information in correspondence with the image change of the face of the user photographed by the image sensor when the user who views the display tilts the case.

In the present invention, the control unit may generate the image control signal including an upper direction, a lower direction, a left direction and a right direction when the user tilts the case in the upper direction, the lower direction, the left direction and the right direction.

In the present invention, the image content distribution server may select the angle of a multi-angle image based on the image control signal.

In the present invention, the multi-angle image is the image photographed by a plurality of cameras connected to the image content distribution server.

According to another aspect of the present invention, there is provided an image display method including: the steps of photographing a subject; detecting motion information of the subject from a photographed image; generating an image control signal from the motion information; and displaying an image selected based on the image control signal.

By this configuration, since the image sensor detects the motion information of the subject from the photographed image to select the image according to the motion information of the subject, it is possible to select the image by a simple operation and simultaneously accomplish miniaturization and excellent operability of the image display device.

In the present invention, the subject may be the face of a user who views the image.

In the present invention, the motion information may be detected in correspondence with the image change of the face of the user.

In the present invention, the image display method may further include the step of selecting the angle of a multi-angle image photographed by a plurality of cameras, based on the image control signal.

According to another aspect of the present invention, there is provided an image display system including: an image display device including an image sensor which photographs a subject, an image processing unit which detects motion information of the subject from an image photographed by the image sensor, a control unit which generates an image control signal from the motion information, and a display which displays an image selected based on the image control signal; and an image content distribution server which receives the image control signal from the image display device over a network, selects an image based on the image control signal, and transmits the selected image to the image display device over the network.

By this configuration, since the image sensor detects the motion information of the subject from the photographed image to select the image according to the motion information of the subject, it is possible to select the image by a simple operation and simultaneously accomplish miniaturization and excellent operability of the image display device.

In the present invention, the image content distribution server may be connected to a plurality of cameras for photographing a multi-angle image, and select the angle of the multi-angle image according to the image control signal received from the image display device.

In the present invention, the image content distribution server may be connected to a file server for storing image contents photographed at multi-angles, and select any one from the image contents based on the image control signal received from the image display device.

According to another aspect of the present invention, there is provided an image display system including: an

image display device including an image sensor which photographs a subject, an image processing unit which detects motion information of the subject from an image photographed by the image sensor, a control unit which generates an image control signal from the motion information, and a display which displays a multi-angle image; and an image recording device which stores the multi-angle image, receives the angle control signal from the image display device over a network to select the angle of the multi-angle image based on the angle control signal, and transmits the selected image to the image display device over the network.

According to another aspect of the present invention, there is provided an image display system including: an external recording medium for storing a multi-angle image and an image display device for displaying the multi-angle image, the image display device including: an image sensor which photographs a subject; an image processing unit which detects motion information of the subject from an image photographed by the image sensor; a control unit which generates the angle control signal from the motion information; and a file system which selects the angle of the multi-angle image based on the angle control signal.

In the present invention, the image display device may include a recording device which copies the multi-angle image from the external recording medium and stores the multi-angle image.

The present invention can solve the first problem related to the reduction in the amount of the information by receiving information on a camera angle desired by a user from an image content distribution server.

Next, since the user tilts the device to control the input, the present invention can accomplish miniaturization and excellent operability of the device. Accordingly, it is possible to realize an angle changing means, without requiring buttons or directional keys in a small-size device without a mouse or a keyboard.

As additional effect, it is possible to reduce the number of buttons or directional keys and to reduce the number of parts. In addition, it is possible to simplify an assembling process and to reduce a failure rate at the time of using the device.

### BRIEF DESCRIPTION OF THE DRAWINGS

FIG. 1 is a view showing a configuration of an image display system according to a first embodiment of the present invention.

FIG. 2 shows an example of an appearance of an image display device.

FIG. 3 shows a relationship between the image display device and a user when viewed from the top.

FIG. 4 shows a relationship between the image display device and the user when the image display device tilts horizontally.

FIG. 5 shows a relationship between the image display device and the user when viewed from the side.

FIG. 6 shows a relationship between the image display device and the user when the image display device tilts vertically.

FIG. 7 is a view explaining a principle of detecting motion information by an image processing unit.

FIG. 8 shows an example of horizontally arranging cameras at a side of a server.

FIG. 9 shows an example of vertically arranging cameras at a side of a sever.

FIG. 10 is an example of a configuration for obtaining image contents from a file server.

FIG. 11 is a view showing a configuration of an image display system according to a second embodiment of the present invention.

FIG. 12 is a view showing a configuration of an image display system according to a third embodiment of the present invention.

FIG. 13 is a view showing a configuration of an image display system according to a fourth embodiment of the present invention.

FIG. 14 is a view showing a schematic configuration of a CCTV system.

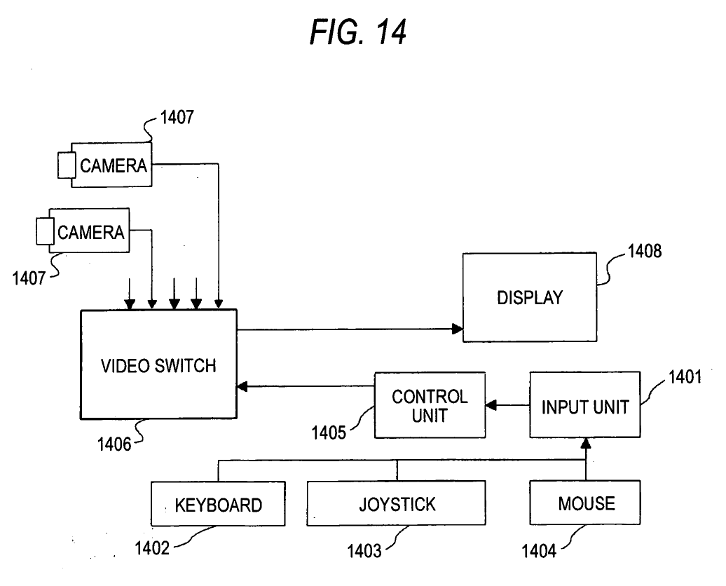

FIG. 15 is a flowchart of an image display method.

### DESCRIPTION OF THE PREFERRED EMBODIMENTS

### First Embodiment

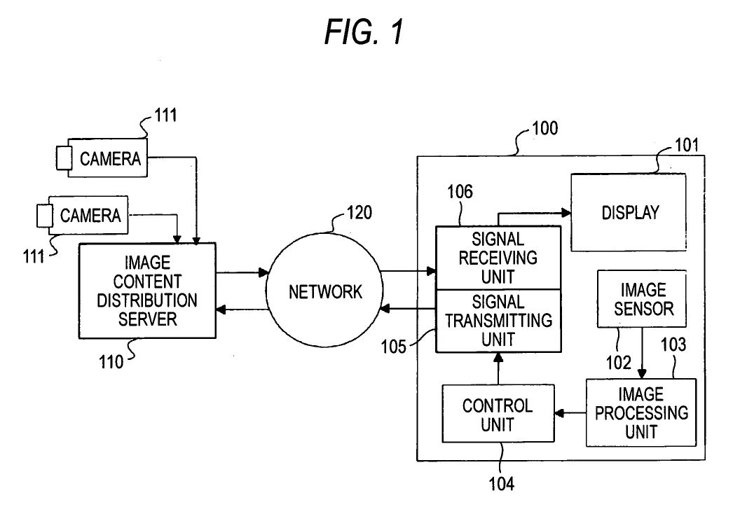

FIG. 1 is a view showing a configuration of an image display system according to a first embodiment of the present invention. In FIG. 1, an image display device 100 includes a display 101, an image sensor 102, an image processing unit 103, a control unit 104, a signal transmitting unit 105, and a signal receiving unit 106.

An image content distribution server 110 can receive an angle control signal from the signal transmitting unit 105 over a network 120. The image content distribution server 110 is connected to a plurality of cameras 111 and can transmit an image signal of one camera to the signal receiving unit 106 over the network 120.

The display 101 is a portable small-sized display part and can use a liquid crystal display device or an organic electroluminescence device. The image sensor 102 photographs a scene surrounding a user's face as an image and may be a complementary metal-oxide semiconductor (CMOS) camera or a charge coupled device (CCD) camera.

The image processing unit 103 detects motion information of the image input by the image sensor 102 and sends the motion information to the control unit 104. The control unit 104 generates an angle control signal according to the motion information of the image and sends the angle control signal to the signal transmitting unit 105.

The signal transmitting unit 105 transmits the angle control signal to the image content distribution server 110 over the network 120. The signal receiving unit 106 receives an image signal from the image content distribution server 110 over the network 120. The display 101 displays the image information received by the signal receiving unit 106.

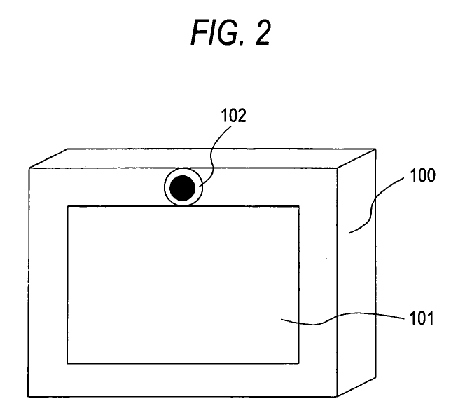

FIG. 2 shows an example of an appearance of the image display device 100. The display 101 and the image sensor 102 are arranged on an identical surface of a case of the image display device 100.

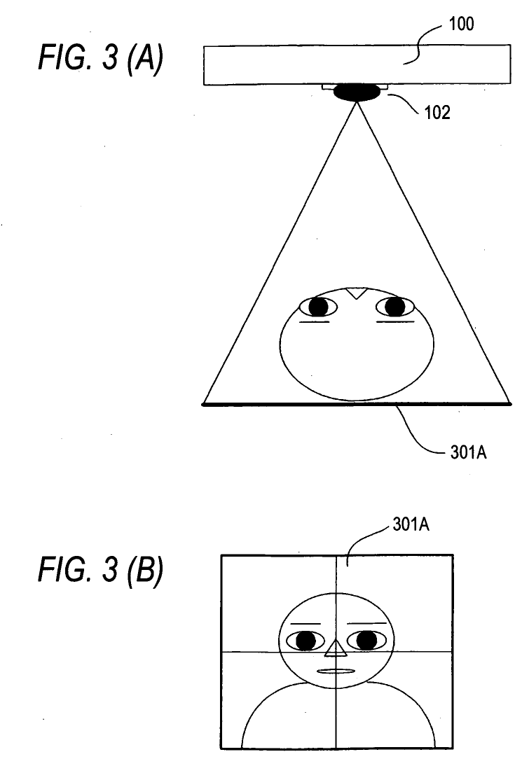

FIG. 3A shows a relationship between the image display device 100 and the user when viewed from the top. The image sensor 102 photographs an image 301A shown in FIG. 3B as the scene surrounding the user's face.

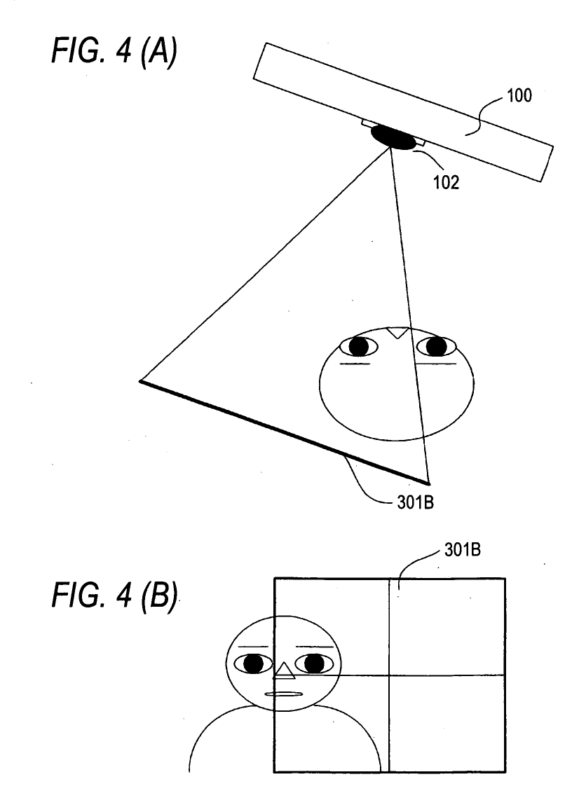

FIG. 4A shows a relationship between the image display device and the user when the image display device 100 tilts horizontally. In this case, the image sensor 102 photographs the right side of the user and thus the user's face moves to the left side as shown by an image 301B of FIG. 4B. When the image display device 100 tilts in an opposite direction thereto, the user's face moves to the right side in the image.

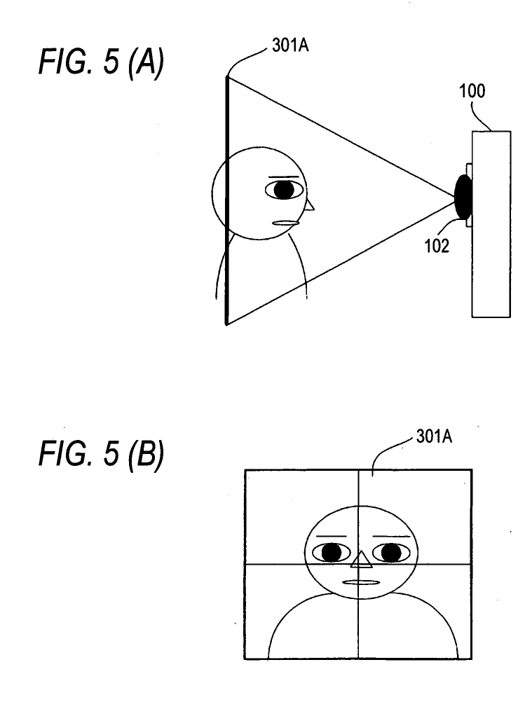

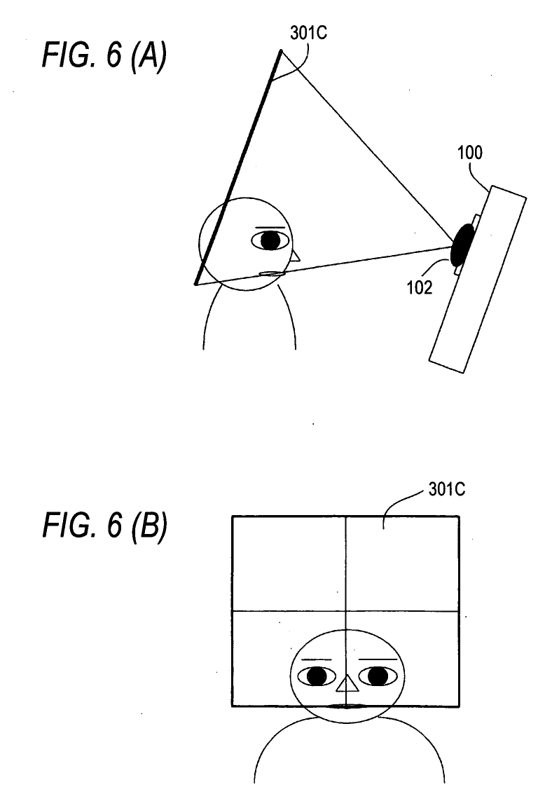

FIG. 5A shows a relationship between the image display device 100 and the user when viewed from the side. Similar to FIG. 3B, an image 301A shown in FIG. 5B is a scene surrounding the user's face. FIG. 6A shows a relationship between the image display device 100 and the user when the image display device tilts upward. In this case, when the image display device 100 tilts upward, the image sensor 102 photographs the upper side of the user's face as shown by an image 301C of FIG. 6B and thus the user's face moves downward in the image. In contrast, when the image display device tilts downward, the user's face moves upward.

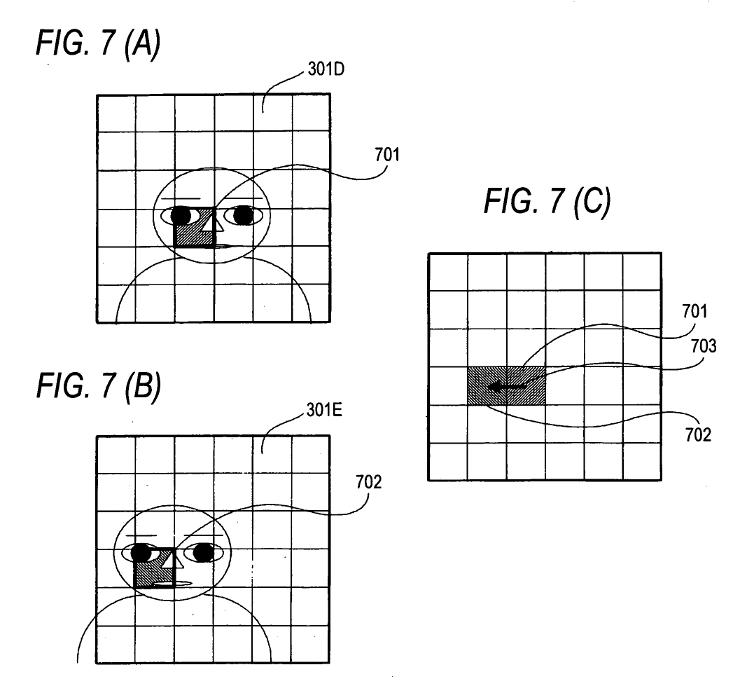

FIG. 7 is a view explaining a principle of detecting the motion information by the image processing unit 103. Two images which are temporally different from each other are divided into latticed blocks and blocks having similar patterns are detected from the images, thereby detecting motion of a block.

In FIG. 7, the images are divided into 6×6 blocks. It can be seen that a pattern which exists in a block 701 of an image 301D shown in FIG. 7A exists in a block 702 of an image 301E shown in FIG. 7B. Accordingly, a motion vector 703 shown in FIG. 7C is obtained from a positional relationship between the block 701 and the block 702.

This method is basically identical to a method of detecting a motion vector used in a current dynamic image compression technology. While the size of the block is 8×8 pixels in a MPEG-4 dynamic image compression technology, the size of the block is 4×4 pixels in a H.264 dynamic image compression technology.

The image processing unit 103 shown in FIG. 1 receives images, which are temporally continuous, from the image sensor 102. The image processing unit 103 compares the images which are photographed at different times and detects whereto the user's face moves in the image.

The image processing unit 103 sends the motion information to the control unit 104. The control unit 104 generates the angle control signal according to the received motion information. The angle control signal includes four directions, that is, a right direction, a left direction, an upper direction and a lower direction.

The angle control signal generated in the control unit 104 is encoded and modulated to be suitable for the network 120, and transmitted by the signal transmitting unit 105. The image content distribution server 110 receives the angle control signal over the network 120.

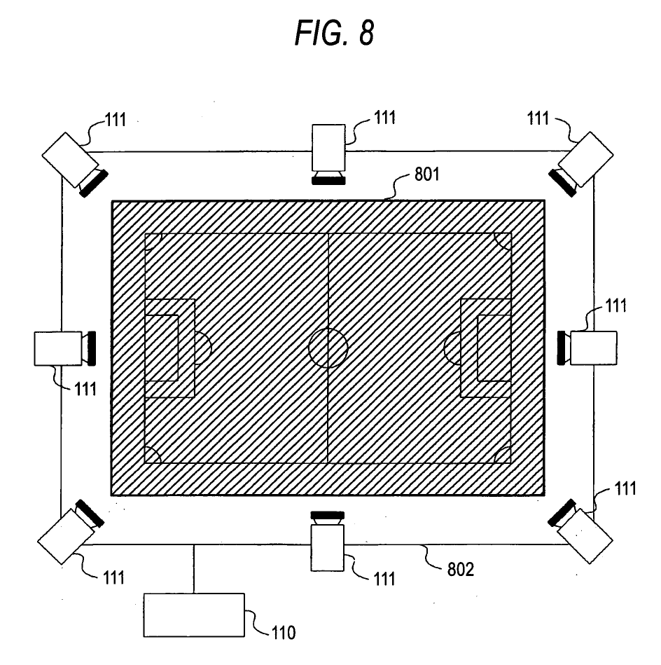

FIG. 8 shows an example of horizontally arranging a plurality of cameras 111 in the image content distribution server 110. In this example, eight cameras 111 are arranged to surround a stadium 801 and connected to the image content distribution server 110 by a transmission path 802. The image content distribution server 110 collects the images of all the cameras, selects any one from the images, and transmits the selected image over the network 120.

The image content distribution server 110 replaces a camera 111 with another camera 111 according to the angle control signal of the image display device 100. In the example of FIG. 8, when the angle control signal is the left direction, the camera 111 is replaced with another camera separated therefrom in a clockwise direction. When the angle control signal is the right direction, the camera 111 is replaced with another camera separated therefrom in a counterclockwise direction. That is, the user horizontally tilts the image display device 100 and thus the camera surrounding the stadium 801 can be selected to control the camera angle.

In this case, when a user A who possesses an image display device 100A selects clockwise rotation and a user B who possesses an image display device 100B selects counterclockwise rotation, the images of the cameras 111 are transmitted in a time division manner such that the user A can view an image which rotates in the clockwise direction and the user B can view a image which rotates in the counterclockwise direction.

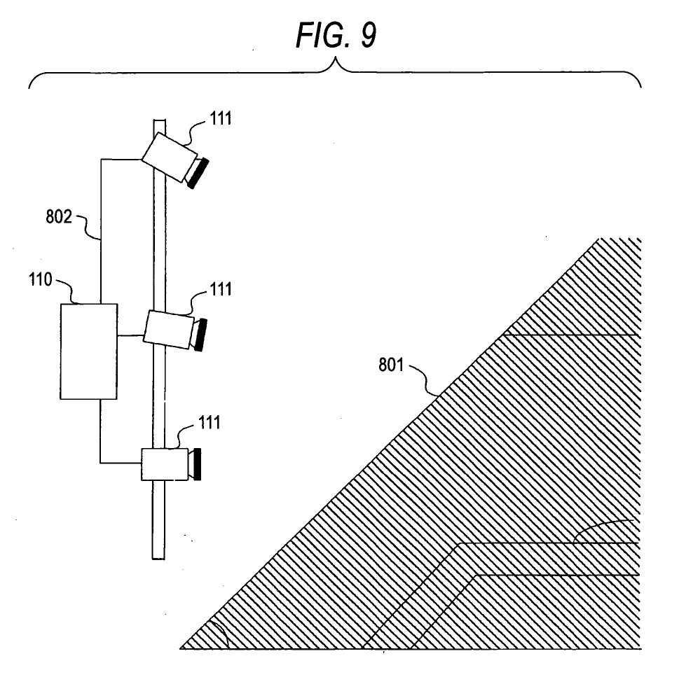

FIG. 9 shows an example in which the cameras 111 connected to the image content distribution server 110 are arranged vertically. In this example, three cameras 111 are arranged at different heights. Similar to the case shown FIG. 8, the image content distribution server 110 can replace a camera 111 with another camera 111 according to the angle control signal.

The image content distribution server 110 replaces a camera 111 with another camera 111 located right above which the angle control signal is the upper direction and replaces a camera 11 with another camera 111 located right below when the angle control signal is the lower direction. That is, when the user vertically tilts the image display device 100, the camera angle can be controlled such that the user can view an image in a viewpoint close to a player or a panoramic viewpoint.

The image signal selected by the image content distribution server 110 is encoded and modulated to be suitable for the network 120 and received by the signal receiving unit 106 over the network 120. The signal receiving unit 106 demodulates and decodes the image and transmits the image signal to the display 101. The display 101 displays the image obtained by the above-described method.

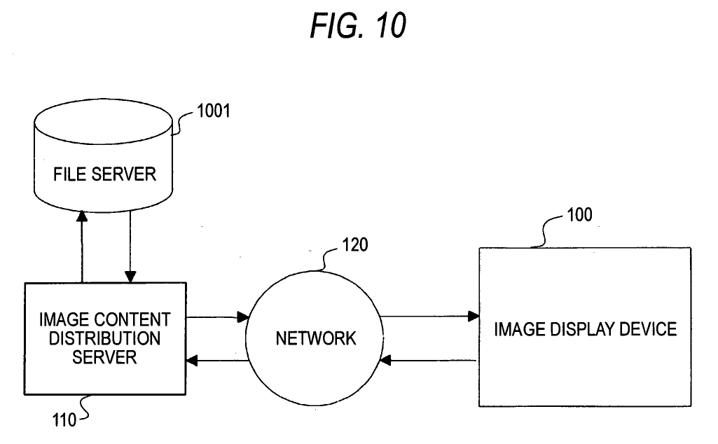

Although, in the first embodiment, the image signal is obtained by the camera 111, the camera may be replaced with a file server 1001, as shown in FIG. 10. In this case, image contents photographed at multi-angles are stored in the file server 1001 and the user can view the image while selecting the camera angle.

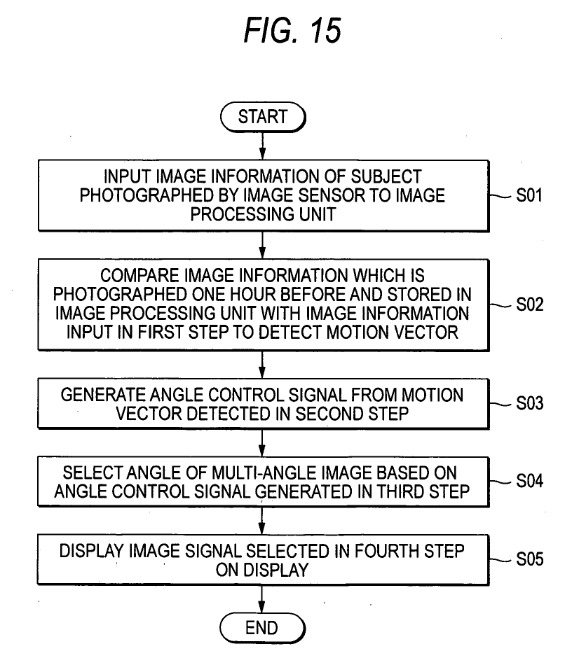

FIG. 15 is a flowchart of an image display method according to the first embodiment. In FIG. 15, in a first step S01, image information of a subject photographed by the image sensor 102 is input to the image processing unit 103. In a second step S02, the image information of the subject which is photographed one hour before and stored in the image processing unit (for example, the image information of FIG. 7A) is compared with the image information input in the first step S01 (for example, the image information of FIG. 7B) to detect the motion vector 703. In a third step S03, the motion vector 703 detected in the second step is sent to the control unit 104, which generates the angle control signal. In a fourth step S04, the angle control signal generated in the third step S03 is transmitted from the signal transmitting unit 105 to the image content distribution server 110 over the network 120 and a camera 111 is selected from the cameras 111 connected to the image content distribution server 110. In a fifth step S05, the image information of the camera selected in the fourth step S04 is transmitted to the signal receiving unit 106 over the network 120 and displayed on the display 101.

### Second Embodiment

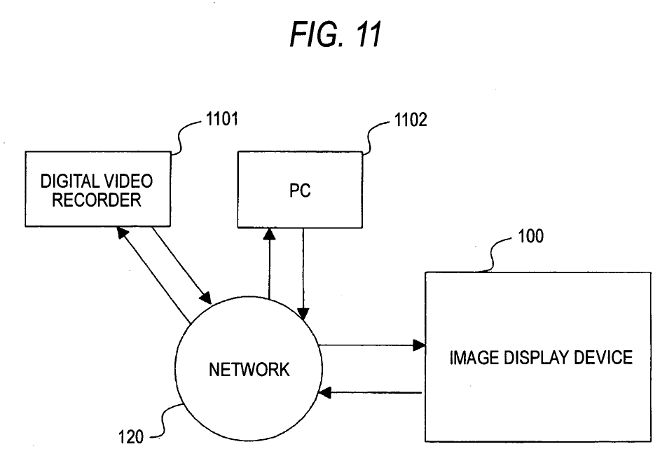

FIG. 11 is a view showing a configuration of an image display system according to a second embodiment of the present invention. In FIG. 11, an image display device 100 transmits/receives information to/from image recording devices such as a digital video recorder 1101 and a PC 1102 over a network 120.

The network 120 may be a home network or a business network. The network 120 may be a wired network or a wireless network. The image display device 100 transmits an angle control signal to the digital video recorder 1101 and the PC 1102 over the network 120 and receives image information from the digital video recorder 1101 and the PC 1102 over the network 120.

### Third Embodiment

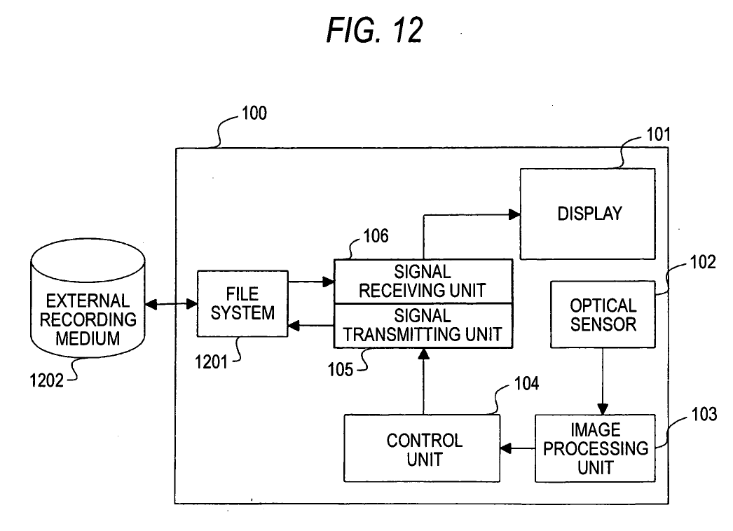

FIG. 12 is a view showing a configuration of an image display system according to a third embodiment of the present invention. In FIG. 12, image contents photographed at multi-angles are stored in an external recording medium 1202. A signal transmitting unit 105 transmits an angle control signal to a file system 1201.

The file system 1201 obtains image information from the external recording medium 1202 according to the angle control signal. The file system 1201 outputs the obtained image information to a signal receiving unit 106. The image information received by the signal receiving unit 106 can be displayed on a display 101.

The external recording medium 1202 described herein may be an optical disk such as CD or DVD, a semiconductor recording device such as a flash memory, or a magnetic disk. The received image information can be displayed on the display 101.

### Fourth Embodiment

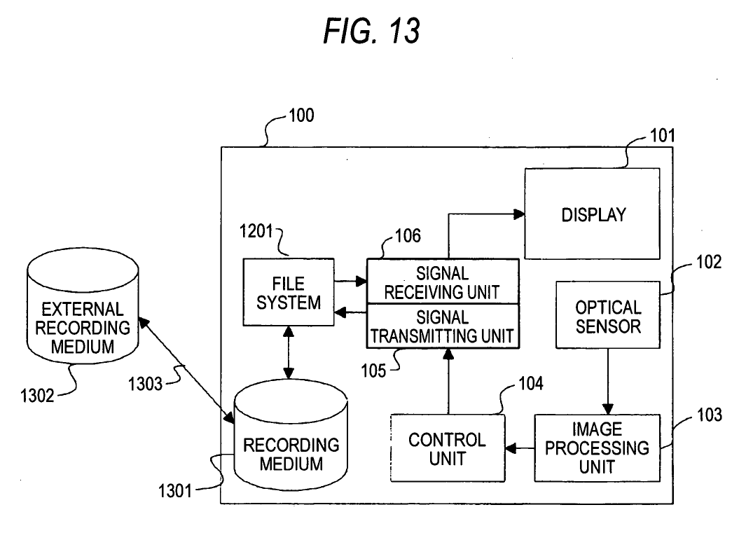

FIG. 13 is a view showing a configuration of an image display system according to a fourth embodiment of the present invention. In FIG. 13, image contents photographed at multi-angles are stored in an external recording device 1302 and an image display device 100 can copy the image contents to an internal recoding device 1301 through a transmission path 1303. The kind of the transmission path 1303 is not specially limited and may be Internet or a broadcasting network.

In the present embodiment, the image contents are previously copied from the external recording device 1302 to the recoding device 1301 before viewing the contents. A signal transmitting unit 105 transmits an angle control signal to a file system 1201. The file system 1201 obtains image information from the recording device 1301 according to the angle control signal. The file system 1201 outputs the obtained image information to a signal receiving unit 106. The image information received by the signal receiving unit 106 can be displayed on a display 101.

The recording device 1301 may be a magnetic disk such as a hard disk or a semiconductor recoding device such as a DRAM or a flash memory.

Although, in the present embodiment, the user's face is photographed by the image sensor 102 to detect the motion information, a subject of the image sensor 102 is not limited to the user's face. For example, motion of a user's finger, motion of a specific person other than a user, or motion of an object may be detected to change a displayed image. Although, in the above description, the angle of the multi-angle image is selected in correspondence with motion information, the magnification, resolution and brightness of the image can be changed in correspondence with the motion of the subject.

According to an image display device, an image display method and an image display system of the present invention, when an image is viewed, a camera angle can be easily changed using an image sensor provided in the image display device and used for the field of information communication such as on-the-spot telecast or video delivery.

The present invention is applicable to the field of education or tourism such as facility tour or visit to a historic spot or a beauty spot. Since the present invention can be used for monitoring a farm, a market or a production line of a factory, the present invention is applicable to a commercial field for improving traceability of product information.

Since the CCTV is essentially a remote monitoring device, the present invention can be used in the field of the security. Since the user can observe an object by controlling the camera angle in a remote place, the present invention is applicable to the fields of nursing care, childcare and medical care.

What is claimed is:

1. An image display device, comprising:
an image sensor, which photographs a subject;
an image processor, which detects motion information of the subject from an image photographed by the image sensor;
a controller, which generates an image control signal from the motion information; and
a display, which displays an image selected based on the image control signal.

2. The image display device according to claim 1, further comprising:
a signal transmitter, which transmits the image control signal to an image content distribution server over a network; and
a signal receiver, which receives the image selected by the image content distribution server based on the image control signal over the network.

3. The image display device according to claim 1, wherein the image sensor is provided in a case of the image display device such that photographing can be performed in the approximately vertical direction of the display surface of the display, and photographs the face of a user who views the display.

4. The image display device according to claim 3, wherein the image processor detects the motion information in correspondence with the image change of the face of the user photographed by the image sensor when the user who views the display tilts the case.

5. The image display device according to claim 4, wherein the controller generates the image control signal including an upper direction, a lower direction, a left direction and a right direction when the user tilts the case in the upper direction, the lower direction, the left direction and the right direction.

6. An image display method comprising the steps of:
photographing a subject;
detecting motion information of the subject from a photographed image;
generating an image control signal from the motion information; and
displaying an image selected based on the image control signal.

7. The image display method according to claim 6, wherein the subject is the face of a user who views the image.

8. The image display method according to claim 7, wherein the motion information is detected in correspondence with the image change of the face of the user.

9. The image display method according to claim 6, further comprising the step of selecting the angle of a multi-angle image photographed by a plurality of cameras, based on the image control signal.

10. An image display system comprising:
an image display, including an image sensor which photographs a subject;
an image processor, which detects motion information of the subject from an image photographed by the image sensor;
a controller, generates an image control signal from the motion information; and
a display, which displays an image selected based on the image control signal; and
an image content distribution server, which receives the image control signal from the image display over a network, selects an image based on the image control signal, and transmits the selected image to the image display device over the network.

11. The image display system according to claim 10, wherein the image content distribution server is connected to a plurality of cameras for photographing a multi-angle image, and selects the angle of the multi-angle image according to the image control signal received from the image display.

12. The image display system according to claim 10, wherein the image content distribution server is connected to a file server for storing image contents photographed at multi-angles, and selects any one from the image contents based on the image control signal received from the image display.

13. An image display system comprising:
an image display, including an image sensor which photographs a subject;
an image processor, which detects motion information of the subject from an image photographed by the image sensor;
a controller, which generates an image control signal from the motion information; and
a display, which displays a multi-angle image; and
an image recorder, which stores the multi-angle image, receives the angle control signal from the image display over a network to select the angle of the multi-angle image based on the angle control signal, and transmits the selected image to the image display over the network.

14. An image display system including an external recording medium for storing a multi-angle image and an image display for displaying the multi-angle image, the image display comprising:
an image sensor, which photographs a subject;
an image processor, which detects motion information of the subject from an image photographed by the image sensor;
a controller, which generates the angle control signal from the motion information; and
a file system, which selects the angle of the multi-angle image based on the angle control signal.

15. The image display system according to claim 14, wherein the image display comprises a recording device which copies the multi-angle image from the external recording medium and stores the multi-angle image.
